(19) United States
(12) Patent Application Publication
(10) Pub. No.: US 2025/0267539 A1
(43) Pub. Date: Aug. 21, 2025

(54) METHODS AND APPARATUSES OF ENHANCEMENTS FOR A CPAC PROCEDURE

(71) Applicant: LENOVO (BEIJING) LIMITED, Beijing (CN)

(72) Inventors: Congchi Zhang, Shanghai (CN); Lianhai Wu, Beijing (CN); Mingzeng Dai, Shanghai (CN); Le Yan, Shanghai (CN)

(21) Appl. No.: 18/856,704

(22) PCT Filed: Apr. 15, 2022
(86) PCT No.: PCT/CN2022/087186

§ 371 Date: Oct. 14, 2024

(51) Int. Cl. H04W 36/08; H04W 76/20; H04W 76/30

(52) U.S. Cl. CPC H04W 36/08; H04W 76/20; H04W 76/30

(57) ABSTRACT

Embodiments of the present application relate to methods and apparatuses of enhancements for a conditional primary cell of a secondary cell group (PSCell) addition and change (CPAC) procedure. According to an embodiment of the present application, a user equipment (UE) includes a transceiver and a processor coupled to the transceiver; and the processor is configured: to determine whether an operating status of a conditional primary secondary cell group cell (PSCell) change (CPC) procedure of a user equipment (UE) will change; and in response to determining that the operating status of the CPC procedure will change, to transmit a message via the transceiver to a secondary node (SN), wherein the message includes an indication for indicating a change of the operating status of the CPC procedure.

### TECHNICAL FIELD

Embodiments of the present application generally relate to methods and apparatuses of enhancements for a conditional primary cell of a secondary cell group (PSCell) addition and change (CPAC) procedure.

### BACKGROUND

Next generation radio access network (NG-RAN) supports a multi-radio dual connectivity (MR-DC) operation. In a MR-DC scenario, a user equipment (UE) with multiple transceivers may be configured to utilize resources provided by two different nodes connected via non-ideal backhauls. One node may provide new radio (NR) access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, Xn interface as specified in 3rd Generation Partnership Project (3GPP) standard documents), and at least the MN is connected to the core network.

Currently, a conditional PSCell addition (CPA) procedure and a conditional PSCell change (CPC) procedure are supported. 3GPP standard document TS38.331 introduce some measurement report events associated with a UE and their entering conditions and leaving conditions, e.g., Event A1, Event A2, Event A3, Event A4, Event A5, Event A6, Event B1, CondEvent A3, CondEvent A5, and Event B2, respectively.

According to agreements of 3GPP standard documents, a conditional PSCell addition and change (CPAC) procedure is defined as a PSCell addition or change that is executed by a UE when execution condition(s) is met. A UE starts evaluating the execution condition(s) upon receiving CPAC configuration information, and stops evaluating the execution condition(s) once a PSCell addition and/or change procedure is triggered.

Furthermore, a CPAC based PSCell or SCG switch procedure is going to be supported. A CPAC based PSCell or SCG switch procedure may also be named as “a CPAC based PSCell/SCG switch procedure”, “a CPAC based fast PSCell switch procedure”, “a CPAC based fast SCG switch procedure” or “an enhanced CPAC procedure” or the like. Currently, in a 3GPP LTE system or 5G system, details regarding enhancements for a CPAC procedure in a MR-DC scenario have not been discussed yet.

### SUMMARY

Some embodiments of the present application provide a master node (MN). The MN includes a transceiver and a processor coupled to the transceiver; and the processor is configured: to determine whether an operating status of a conditional primary secondary cell group cell (PSCell) change (CPC) procedure of a user equipment (UE) will change; and in response to determining that the operating status of the CPC procedure will change, to transmit a first message via the transceiver to a first secondary node (SN), wherein the first message includes a first indication for indicating a change of the operating status of the CPC procedure.

In some embodiments, a configuration related to the CPC procedure is not released by the UE upon the UE switching to a PSCell during the CPC procedure.

In some embodiments, the change of the operating status of the CPC procedure includes at least one of: an initiation of the CPC procedure; a start of the CPC procedure; a stop of the CPC procedure; a suspending of the CPC procedure; a resumption of the CPC procedure; or a successful PSCell change during the CPC procedure.

In some embodiments, the UE is connected to the first SN when receiving a configuration related to the CPC procedure, and the processor of the MN is configured to transmit a second message including the first indication via the transceiver to a second SN associated with a candidate PSCell of the UE.

In some embodiments, the first message is a SN modification request message, and the second message is a SN addition request message.

In some embodiments, the first SN is associated with a candidate PSCell of the UE during the CPC procedure, and the processor of the MN is configured to receive a third message including the first indication via the transceiver from a SN to which the UE is connected when receiving a configuration related to the CPC procedure.

In some embodiments, the first message is a SN addition request message, and the third message is a SN change required message.

In some embodiments, the third message is received before transmitting the first message, and the processor of the MN is configured to determine that the operating status of the CPC procedure will change based on the third message.

In some embodiments, the processor of the MN is configured to receive a first reconfiguration complete message associated with the CPC procedure via the transceiver from the UE.

In some embodiments, the processor of the MN is configured to receive a second reconfiguration complete message associated with the CPC procedure via the transceiver from the UE.

In some embodiments, the first reconfiguration complete message and the second reconfiguration complete message are related to a same radio resource control (RRC) reconfiguration procedure identified by an RRC transaction identifier.

In some embodiments, a first reconfiguration procedure is not terminated by the UE upon a transmission of at least one of the first reconfiguration complete message or the second reconfiguration complete message.

In some embodiments, the processor of the MN is configured to transmit at least one of the first reconfiguration complete message or the second reconfiguration complete message via the transceiver to a third SN associated with a target PSCell of the UE.

In some embodiments, the at least one of the first reconfiguration complete message or the second reconfiguration complete message is encapsulated in an RRC message.

In some embodiments, a second reconfiguration procedure is not terminated by the third SN upon a reception of the at least one of the first reconfiguration complete message or the second reconfiguration complete message.

In some embodiments, the first SN and the third SN are identical or different.

In some embodiments, the processor of the MN is configured to receive one or more reconfiguration complete messages associated with the CPC procedure via the transceiver from a UE.

In some embodiments, the one or more reconfiguration complete messages are generated by the UE upon a reception of a configuration related to the CPC procedure.

In some embodiments, the one or more reconfiguration complete messages are generated by the UE upon both a reception of a configuration related to the CPC procedure and a successful completion of a compliance check operation.

In some embodiments, the processor of the MN is configured to not receive any reconfiguration complete message via the transceiver from the UE upon triggering the UE to switch to a candidate PSCell during the CPC procedure.

In some embodiments, the processor of the MN is configured to transmit each of the one or more reconfiguration complete messages via the transceiver to a fourth SN associated with a candidate PSCell of the UE upon a reception of the one or more reconfiguration complete messages.

In some embodiments, in response to the UE being connected to the first SN when receiving a configuration related to the CPC procedure and in response to the change of the operating status of the CPC procedure including a successful PSCell change during the CPC procedure, the processor of the MN is configured: to receive a fourth message via the transceiver from a fifth SN associated with a target PSCell of the UE, wherein the fourth message includes identifier (ID) information of the target PSCell; or to receive an RRC message different from a reconfiguration complete message via the transceiver from the UE, wherein the RRC message includes ID information of the target PSCell.

In some embodiments, the fourth message includes a second indication for indicating a successful completion of a random access (RA) to the target PSCell.

In some embodiments, the first message includes the ID information of the target PSCell.

In some embodiments, at least one of the first message or the fourth message is in a messaging procedure requiring a response from a peer node or in a messaging procedure not requiring the response from the peer node.

In some embodiments, the first SN is associated with a target PSCell of the UE, and the processor of the MN is configured to receive a fifth message including the first indication via the transceiver from a sixth SN associated with a current serving PSCell of the UE or from a seventh SN to which the UE is connected when receiving a configuration related to the CPC procedure.

In some embodiments, the fifth message is at least one of: a SN change required message; a SN release required message; or a SN modification required message.

In some embodiments, in response to the change of the operating status of the CPC procedure including a stop of the CPC procedure, the processor of the MN is configured: to release one or more configurations of all PSCells related to the CPC procedure; or to keep a connection between the UE and a current serving PSCell of the UE and to release one or more configurations of other PSCells related to the CPC procedure.

In some embodiments, to release the one or more configurations of the all PSCells related to the CPC procedure, the processor of the MN is configured to transmit a SN release request message via the transceiver to each SN within all SNs associated with the all PSCells; or to release the one or more configurations of the other PSCells related to the CPC procedure, the processor of the MN is configured to transmit the SN release request message via the transceiver to each SN within a set of SNs associated with the other PSCells.

In some embodiments, to keep the connection between the UE and the current serving PSCell of the UE and to release the one or more configurations of the other PSCells related to the CPC procedure, the first message transmitted by the MN is a SN modification request message, and the SN is associated with the current serving PSCell of the UE.

In some embodiments, in response to the change of the operating status of the CPC procedure including a suspending or a resumption of the CPC procedure, the first message is a SN modification request message.

In some embodiments, in response to the change of the operating status of the CPC procedure including a suspending or a resumption of the CPC procedure, the processor of the MN is configured to transmit a SN modification request message via the transceiver to each SN within a set of SNs associated with other PSCells except the current serving PSCell of the UE.

Some embodiments of the present application provide a method performed by a MN. The method includes: determining whether an operating status of a conditional primary secondary cell group cell (PSCell) change (CPC) procedure of a user equipment (UE) will change; and transmitting a first message to a secondary node (SN), wherein the first message includes a first indication for indicating a change of the operating status of the CPC procedure, in response to determining that the operating status of the CPC procedure will change.

Some embodiments of the present application also provide a secondary node (SN). The SN includes a transceiver and a processor coupled to the transceiver; and the processor is configured to communicate a first message via the transceiver with a master node (MN), wherein the first message includes a first indication for indicating a change of an operating status of a conditional primary secondary cell group cell (PSCell) change (CPC) procedure of a user equipment (UE).

In some embodiments, a configuration related to the CPC procedure is not released by the UE upon the UE switching to a PSCell during the CPC procedure.

In some embodiments, the change of the operating status of the CPC procedure includes at least one of: an initiation of the CPC procedure; a start of the CPC procedure; a stop of the CPC procedure; a suspending of the CPC procedure; a resumption of the CPC procedure; or a successful PSCell change during the CPC procedure.

In some embodiments, the SN is: connected to the UE when the UE receives a configuration related to the CPC procedure; or associated with a candidate PSCell of the UE; or associated with a target PSCell of the UE; or associated with a current serving PSCell of the UE.

In some embodiments, the first message is at least one of: a SN release request message; a SN addition request message; a SN change required message; a SN release required message; a SN modification required message; a reconfiguration complete message; or a SN modification request message.

In some embodiments, to communicate the first message, the processor of the SN is configured: to receive the first message via the transceiver from the MN; and to determine the change of the operating status of the CPC procedure based on the first indication in the first message.

In some embodiments, to communicate the first message, the processor of the SN is configured: to determine whether the operating status of the CPC procedure will change; and in response to determining that the operating status of the CPC procedure will change, to transmit the first message including the first indication via the transceiver to the MN.

In some embodiments, in response to the change of the operating status of the CPC procedure including a stop of the CPC procedure, the processor of the SN is configured to receive a SN release request message via the transceiver from the MN.

In some embodiments, the processor of the SN is configured to receive one or more reconfiguration complete messages associated with the CPC procedure via the transceiver from the MN.

In some embodiments, the one or more reconfiguration complete messages are encapsulated in a radio resource control (RRC) message.

In some embodiments, the one or more reconfiguration complete messages are related to a same RRC reconfiguration procedure identified by an RRC transaction identifier.

In some embodiments, a first reconfiguration procedure is not terminated by the UE upon a transmission of the one or more reconfiguration complete messages to the MN.

In some embodiments, the processor of the SN is configured to not terminate a second reconfiguration procedure upon a reception of the one or more reconfiguration complete messages.

In some embodiments, the one or more reconfiguration complete messages are generated by the UE upon a reception of a configuration related to the CPC procedure.

In some embodiments, the one or more reconfiguration complete messages are generated by the UE upon both a reception of a configuration related to the CPC procedure and a successful completion of a compliance check operation.

In some embodiments, the SN is associated with a target PSCell of the UE, and the processor of the SN is configured to transmit a fourth message including identifier (ID) information of the target PSCell via the transceiver to the MN.

In some embodiments, the fourth message includes a second indication for indicating a successful completion of a random access (RA) to the target PSCell.

In some embodiments, at least one of the first message or the fourth message is in a messaging procedure requiring a response from a peer node or in a messaging procedure not requiring the response from the peer node.

Some embodiments of the present application provide a method performed by a SN. The method includes communicating a first message with a master node (MN). The first message includes a first indication for indicating a change of an operating status of a conditional primary secondary cell group cell (PSCell) change (CPC) procedure of a user equipment (UE).

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a network node (a MN or a SN).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary flowchart of indicating a change of the operating status of a CPC procedure in accordance with some embodiments of the present application.

FIGS. 3 and 4 illustrate flowcharts of exemplary procedures of wireless communications in accordance with some embodiments of the present application.

FIG. 5 illustrates a flow chart of an exemplary procedure of wireless communications in accordance with some embodiments of the present application.

FIGS. 6-8 illustrate flowcharts of exemplary procedures of wireless communications in accordance with some embodiments of the present application.

FIG. 9 illustrates an exemplary block diagram of an apparatus for a CPC procedure in accordance with some embodiments of the present application.

FIG. 10 illustrates a further exemplary block diagram of an apparatus for a CPC procedure in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, the Xn interface as specified in 3GPP standard documents. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a master cell group (MCG). The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a secondary cell group (SCG). The SCG may refer to a group of serving cells associated with SN 103, and may include a primary secondary cell (PSCell) and optionally one or more secondary cells (SCells). The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

More specifically, embodiments of the present application specify details regarding enhancements for a CPAC procedure in a MR-DC scenario. For example, some embodiments of the present application define a new defined Xn/X2 message, a new indicator, or a new information element (IE) in existing Xn/X2 message to indicate a change of an operating status of the CPC procedure. Some embodiments of the present application study how to indicate relevant RAN nodes about an initiation or a start of the CPC procedure. Some further embodiments of the present application study how to indicate a source PSCell about an execution of PSCell change during the CPC procedure. Some other embodiments of the present application study how to indicate relevant RAN nodes about a stop, a suspending, or a resumption of the CPC procedure. More details regarding the embodiments of the present application will be illustrated in the following text in combination with the appended drawings.

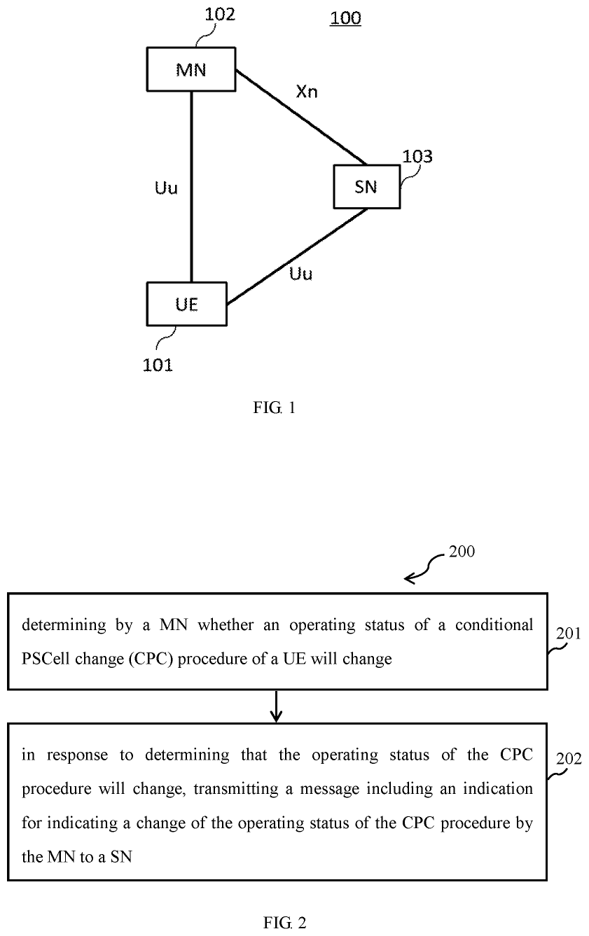

FIG. 2 illustrates an exemplary flowchart of indicating a change of the operating status of a CPC procedure in accordance with some embodiments of the present application. The exemplary procedure 200 in the embodiments of FIG. 2 may be performed by a MN, e.g., MN 102 as shown in FIG. 1. Although described with respect to a MN, it should be understood that other devices may be configured to perform a method similar to that of FIG. 2.

In the exemplary procedure 200 as shown in FIG. 2, in operation 201, a MN determines whether an operating status of a CPC procedure of a UE (e.g., UE 101 as shown in FIG. 1) will change. In operation 202, in response to determining that the operating status of the CPC procedure will change, the MN transmits a message, which includes an indication (named as “1st indication” for simplicity) for indicating a change of the operating status of the CPC procedure, to a SN (named as “1st SN” for simplicity, e.g., SN 103 as shown in FIG. 1).

In some embodiments, a configuration related to the CPC procedure is not released by the UE upon the UE switching to a PSCell during the CPC procedure. In some embodiments, the CPC procedure may be named as “an enhanced conditional PSCell change (eCPC) procedure” or “a consecutive conditional PSCell change (CCPC) procedure” or the like. These embodiments may refer to a specific scenario in a CPAC based PSCell/SCG switch procedure that after providing the conditional configuration(s) associated with candidate PSCells (e.g., similar to those for CPAC) to a UE, the UE may continue to perform PSCell/SCG switching according to the conditional configuration(s) and will not release the conditional configuration(s) upon switching to a new PSCell during the PSCell/SCG switch procedure. For example, during the eCPC procedure, after providing conditional configuration(s) associated with candidate PSCell(s) to a UE, the UE may perform a consecutive or enhanced PSCell/SCG switch procedure according to the conditional configuration(s) and will not release the conditional configuration(s) upon switching to a new PSCell during the consecutive or enhanced PSCell/SCG switch procedure. The non-released conditional configuration(s) may be reused by the UE in a subsequent switching operation to a PSCell in the eCPC procedure. During the eCPC procedure, a UE may switch between different PSCells according to conditional configuration(s) (e.g., consisting of execution condition(s) and/or radio configuration(s) for each candidate PSCell) configured by a network. When the eCPC procedure is started, a UE switches between candidate PSCells according to the execution condition(s) and does not release the conditional configuration(s) when switching between different PSCells.

In some embodiments, the change of the operating status of the CPC procedure includes at least one of: an initiation of the CPC procedure; a start of the CPC procedure; a stop of the CPC procedure; a suspending of the CPC procedure; a resumption of the CPC procedure; or a successful PSCell change during the CPC procedure.

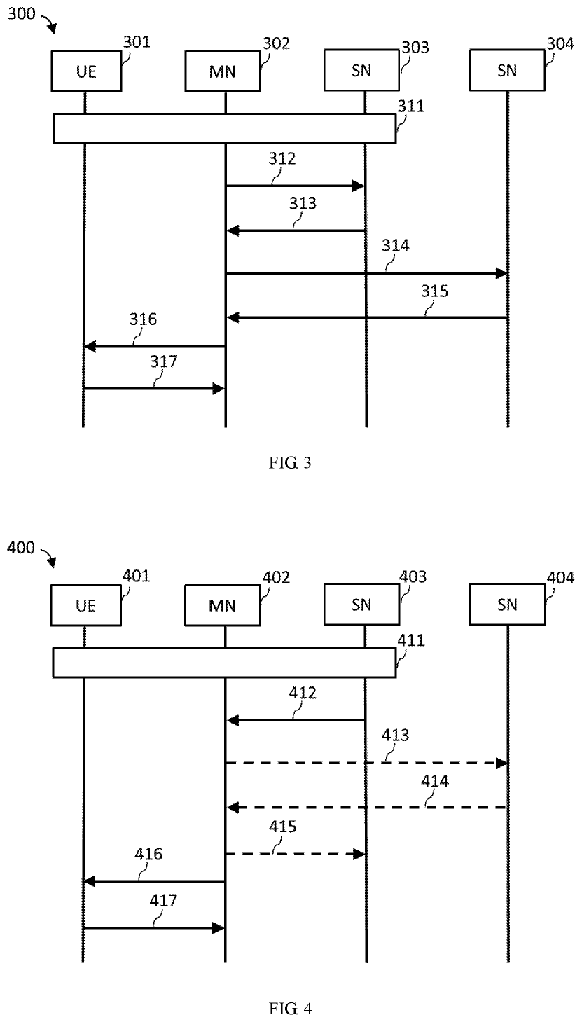

In some embodiments, the UE is connected to the SN when receiving a configuration related to the CPC procedure, and the MN transmits a further message including the 1st indication to a further SN associated with a candidate PSCell of the UE. In an embodiment, the message in operation 202 is a SN modification request message, and the further message is a SN addition request message. A specific example is described in the embodiments of FIG. 3 as below.

In some other embodiments, the 1st SN is associated with a candidate PSCell of the UE during the CPC procedure, and the MN receives an additional message including the 1st indication from another SN to which the UE is connected when receiving a configuration related to the CPC procedure. In an embodiment, the message in operation 202 is a SN addition request message, and the additional message is a SN change required message. In an embodiment, the additional message is received by the MN before the MN transmitting the message in operation 202, and the MN may determine that the operating status of the CPC procedure will change based on the additional message. A specific example is described in the embodiments of FIG. 4 as below.

In some embodiments, the MN receives a reconfiguration complete message associated with the CPC procedure from the UE. In an embodiment, the MN may receive a further reconfiguration complete message associated with the CPC procedure from the UE. The reconfiguration complete message and the further reconfiguration complete message may be related to the same radio resource control (RRC) reconfiguration procedure identified by an RRC transaction identifier. For instance, these two reconfiguration complete messages include the same RRC transaction identifier. A specific example is described in the embodiments of FIG. 5 as below.

In some embodiments, the UE does not terminate a reconfiguration procedure (e.g., an RRC reconfiguration procedure) upon a transmission of the reconfiguration complete message and/or the further reconfiguration complete message.

In some embodiments, the MN transmits the reconfiguration complete message and/or the further reconfiguration complete message to a SN associated with a target PSCell of the UE (named as “2nd SN” for simplicity). For example, the reconfiguration complete message and/or the further reconfiguration complete message may be encapsulated in an RRC message, e.g., a MN RRC message. In an embodiment, the 2nd SN does not terminate a reconfiguration procedure (e.g., an RRC reconfiguration procedure) upon a reception of the reconfiguration complete message and/or the further reconfiguration complete message. For instance, the 1st SN and the 2nd SN may be identical or different.

In some embodiments, the MN receives one or more reconfiguration complete message(s) associated with the CPC procedure from the UE. In an embodiment, such messages are generated by the UE upon a reception of a configuration related to the CPC procedure. In a further embodiment, such messages are generated by the UE upon both a reception of a configuration related to the CPC procedure and a successful completion of a compliance check operation. In some other embodiments, the MN transmits each of such messages to a SN associated with a candidate PSCell of the UE upon a reception of such messages.

In a case that the UE is connected to the 1st SN when receiving a configuration related to the CPC procedure and in a case that the change of the operating status of the CPC procedure includes a successful PSCell change during the CPC procedure, in an embodiment, the MN may receive a message, which includes identifier (ID) information of a target PSCell of the UE, from a SN associated with the target PSCell of the UE (named as “3rd SN” for simplicity). For example, this message includes a further indication for indicating a successful completion of a random access (RA) to the target PSCell. In another embodiment, the MN may receive an RRC message, which is different from a reconfiguration complete message and includes ID information of the target PSCell, from the UE. In the abovementioned two embodiments, the message transmitted in operation 202 may include the ID information of the target PSCell.

For instance, the message including the 1st indication transmitted in operation 202 and/or the message including the further indication may be in “a messaging procedure requiring a response from a peer node” (e.g., class 1 Xn/X2 messaging procedure as specified in 3GPP standard document TS38.423) or in “a messaging procedure not requiring the response from the peer node” (e.g., class 2 Xn/X2 messaging procedure as specified in 3GPP standard document TS38.423). A specific example is described in the embodiments of FIG. 5 as below.

In some embodiments, the MN does not receive any reconfiguration complete message from the UE upon triggering the UE to switch to a candidate PSCell during the CPC procedure. A specific example is described in the embodiments of FIG. 5 as below.

In an embodiment, the 1st SN is associated with a target PSCell of the UE, and the MN receives another message including the 1st indication from “a SN associated with a current serving PSCell of the UE” or from “a SN to which the UE is connected when receiving a configuration related to the CPC procedure”. The abovementioned another message may be: a SN change required message; a SN release required message; and/or a SN modification required message.

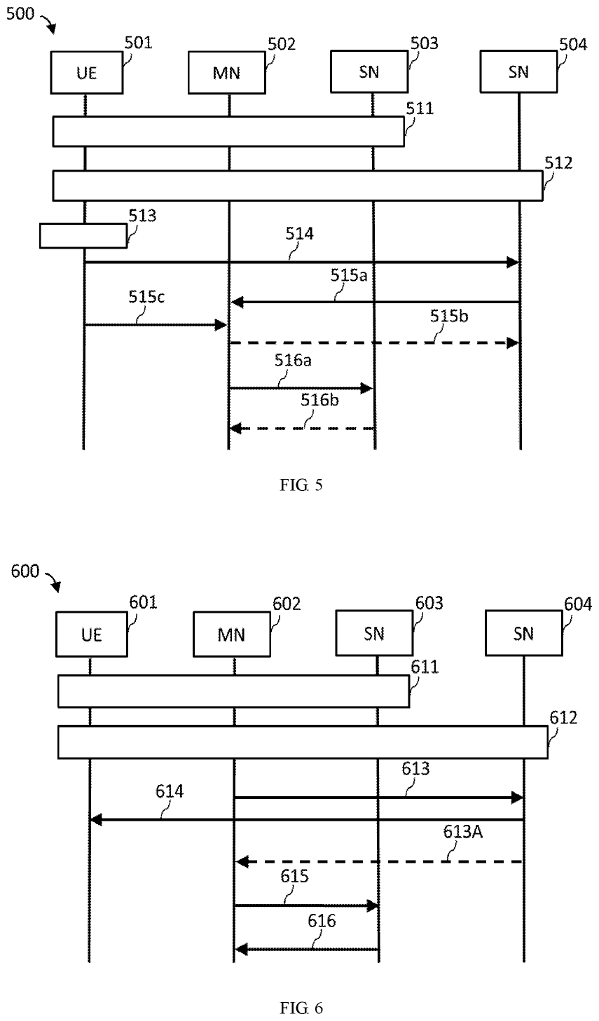

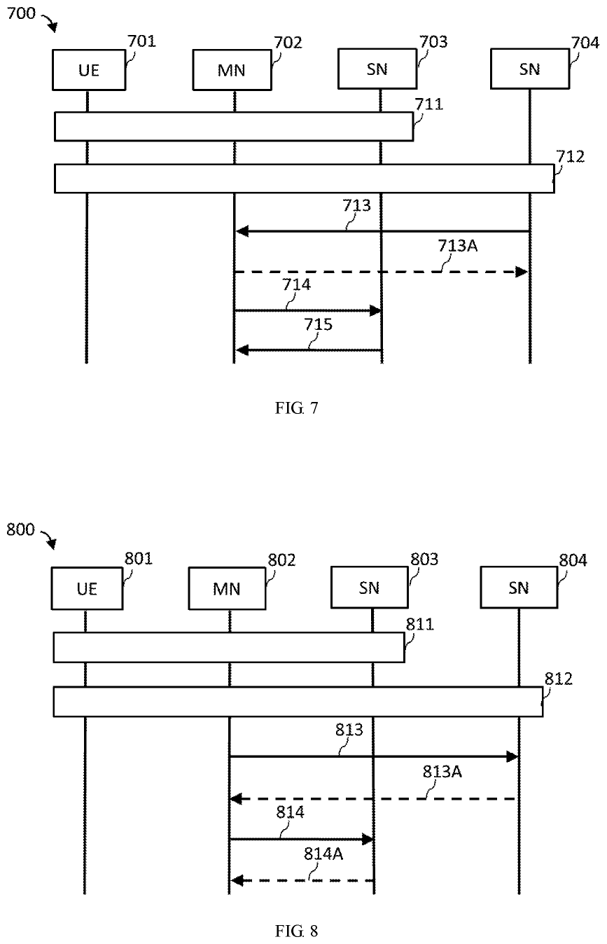

In a case that the change of the operating status of the CPC procedure includes a stop of the CPC procedure, in some embodiments, the MN releases one or more configurations of all PSCells related to the CPC procedure. For example, the MN transmits a SN release request message to each SN within all SNs associated with the all PSCells. In some other embodiments, the MN keeps a connection between the UE and a current serving PSCell of the UE, and releases one or more configurations of other PSCells related to the CPC procedure. For example, the MN transmits the SN release request message to each SN within a set of SNs associated with the other PSCells. In the abovementioned embodiments, the message transmitted in operation 202 may be a SN modification request message. A specific example is described in the embodiments of FIGS. 6 and 7 as below.

In some embodiments, in a case that the change of the operating status of the CPC procedure includes a suspending or a resumption of the CPC procedure, the message transmitted in operation 202 may be a SN modification request message. In some other embodiments, in a case that the change of the operating status of the CPC procedure includes a suspending or a resumption of the CPC procedure, the MN transmits a SN modification request message to each SN within a set of SNs associated with other PSCells except the current serving PSCell of the UE. Specific examples are described in the embodiments of FIGS. 7 and 8 as below.

It should be appreciated by persons skilled in the art that the sequence of the operations in exemplary procedure 200 may be changed and some of the operations in exemplary procedure 200 may be eliminated or modified, without departing from the spirit and scope of the disclosure. Details described in all other embodiments of the present application (for example, details regarding enhancements for a CPAC procedure) are applicable for the embodiments of FIG. 2. Moreover, details described in the embodiments of FIG. 2 are applicable for all the embodiments of FIGS. 1, and 3-10.

In addition, some embodiments of the present application provide an exemplary flowchart of communicating an indication for indicating a change of an operating status of a CPC procedure in accordance with some embodiments of the present application, which may be performed by a SN (e.g., SN 103 as shown in FIG. 1). Although described with respect to a SN, it should be understood that other devices may be configured to perform a similar method.

It should be appreciated by persons skilled in the art that the sequence of the operations in this exemplary flowchart of a SN may be changed and some of the operations in this exemplary flowchart may be eliminated or modified, without departing from the spirit and scope of the disclosure. Details described in all other embodiments of the present application, e.g., in the embodiments of FIG. 2 (for example, all details regarding enhancements for a CPAC procedure) are applicable for this exemplary flowchart. Moreover, details described in this exemplary flowchart are applicable for all the embodiments of FIGS. 1-10.

In particular, in this exemplary flowchart, a SN (e.g., SN 103 as shown in FIG. 1) communicates a message with a MN (e.g., MN 102 as shown in FIG. 1). The message includes an indication (named as “1st indication” for simplicity) for indicating a change of an operating status of a CPC procedure of a UE (e.g., UE 101 as shown in FIG. 1).

In some embodiments, a configuration related to the CPC procedure is not released by the UE upon the UE switching to a PSCell during the CPC procedure. In some embodiments, the CPC procedure may be named as “an eCPC procedure” or “a CCPC procedure” or the like.

In some embodiments, the change of the operating status of the CPC procedure includes at least one of: an initiation of the CPC procedure; a start of the CPC procedure; a stop of the CPC procedure; a suspending of the CPC procedure; a resumption of the CPC procedure; or a successful PSCell change during the CPC procedure.

In some embodiments, the SN may be connected to the UE when the UE receives a configuration related to the CPC procedure, or may be associated with a candidate PSCell of the UE; or associated with a target PSCell of the UE, or may be associated with a current serving PSCell of the UE.

In some embodiments, the message including the 1st indication may be at least one of: a SN release request message; a SN addition request message; a SN change required message; a SN release required message; a SN modification required message; a reconfiguration complete message; or a SN modification request message.

In some embodiments, the SN receives the message including the 1st indication from the MN, and determines the change of the operating status of the CPC procedure based on the 1st indication in the message. In some other embodiments, the SN determines whether the operating status of the CPC procedure will change. In response to determining that the operating status of the CPC procedure will change, the SN transmits the message including the 1st indication to the MN.

In some embodiments, in response to the change of the operating status of the CPC procedure including a stop of the CPC procedure, the SN receives a SN release request message from the MN. Specific examples are described in the embodiments of FIGS. 6 and 7 as below.

In some embodiments, the SN receives one or more reconfiguration complete messages associated with the CPC procedure from the MN. In an embodiment, such messages are encapsulated in an RRC message, e.g., a MN RRC message. In an embodiment, such messages are related to the same RRC reconfiguration procedure identified by an RRC transaction identifier, e.g., including the same RRC transaction identifier. A specific example is described in the embodiments of FIG. 5 as below.

In some embodiments, the UE does not terminate a reconfiguration procedure (e.g., an RRC reconfiguration procedure) upon a transmission of the one or more reconfiguration complete messages to the MN. In some embodiments, the SN does not terminate a reconfiguration procedure (e.g., an RRC reconfiguration procedure) upon a reception of the one or more reconfiguration complete messages.

In some embodiments, the one or more reconfiguration complete messages are generated by the UE upon a reception of a configuration related to the CPC procedure. In some other embodiments, the one or more reconfiguration complete messages are generated by the UE upon both a reception of a configuration related to the CPC procedure and a successful completion of a compliance check operation.

In some embodiments, the SN is associated with a target PSCell of the UE, and the SN transmits a further message including ID information of the target PSCell to the MN. In an embodiment, the further message includes a further indication for indicating a successful completion of a RA to the target PSCell.

In some embodiments, the message including the 1st indication and/or the further message including the further indication may be in “a messaging procedure requiring a response from a peer node” (e.g., class 1 Xn/X2 messaging procedure) or in “a messaging procedure not requiring the response from the peer node” (e.g., class 2 Xn/X2 messaging procedure). A specific example is described in the embodiments of FIG. 5 as below.

FIGS. 3 and 4 illustrate flowcharts of exemplary procedures of wireless communications in accordance with some embodiments of the present application. The exemplary procedures 300 and 400 refer to an initiation or a start of a CPC procedure between a MN and a SN. In embodiments of FIGS. 3 and 4, a new indicator or IE is used to indicate a start of a CPC procedure between a MN and a SN.

Referring to FIG. 3, UE 301, MN 302 and SN 303 may function as UE 101, MN 102, and SN 103 as shown in FIG. 1, respectively. SN 304 may be another SN not shown in FIG. 1. In particular, the exemplary procedure 300 refers to a MN triggered initiation of a CPC procedure or a MN triggered start of a CPC procedure, and following steps are performed.
(1) Step 311: UE 301, MN 302 and SN 303 perform a SN addition procedure, and UE 301 is connected to MN 302 and SN 303.
(2) Steps 312-315: MN 302 requests SN 303 to prepare multiple candidate PSCells for a CPC procedure in at least one of following two ways, i.e., Way #1 and Way #2.
   a) Way #1: In Step 312, MN 302 transmits a SN modification request message (e.g., SN MODIFICATION REQUEST Xn message) to an existing or connected SN, i.e., SN 303. MN 302 adds an indicator or an IE which implies an initiation or a start of the CPC procedure in the SN modification request message. In Step 313, SN 303 transmits a SN modification request acknowledge message (e.g., SN MODIFICATION REQUEST ACKNOWLEDGE Xn message), which includes configuration(s) of candidate PSCell(s), to MN 302
   b) Way #2: In Step 314, MN 302 transmits a SN addition request message (e.g., SN ADDITION REQUEST Xn message) sent to a new SN, e.g., SN 304. MN 302 adds an indicator or an IE which implies an initiation or a start of the CPC procedure in the SN addition request message. In Step 315, SN 304 transmits a SN addition request acknowledge message (e.g., SN ADDITION REQUEST ACKNOWLEDGE Xn message), which includes configuration(s) of candidate PSCell(s), to MN 302.
(3) Step 316: MN 302 transmits an RRC reconfiguration message, which includes the configuration(s) of candidate PSCell(s), to UE 301.
(4) Step 317: UE 301 transmits an RRC reconfiguration complete message to MN 302.

Referring to FIG. 4, UE 401, MN 402 and SN 403 may function as UE 101, MN 102, and SN 103 as shown in FIG. 1, respectively. SN 404 may be another SN not shown in FIG. 1. In particular, the exemplary procedure 400 refers to a SN triggered initiation of a CPC procedure or a SN triggered start of CPC procedure, and following steps are performed.
(1) Step 411: UE 401, MN 402 and SN 403 perform a SN addition procedure, and UE 401 is connected to MN 402 and SN 403.
   a) In some embodiments, SN 403 already connected to MN 402 may be named as “a source SN” or the like. That is, UE 401 is connected to a source SN when receiving configuration(s) related to the CPC procedure.
(2) After Step 411, SN 403 may indicate an initiation or a start of a CPC procedure. There may be following two ways according to different embodiments:
   a) For a SN initiated inter SN CPC procedure, Steps 412-415 are performed.
      1) In Step 412, SN 403 transmits a SN change required message (e.g., SN CHANGE REQUIRED Xn message) to MN 402. SN 403 adds an indicator or IE which implies an initiation or a start of the CPC procedure together with “a set of suggested candidate PSCell(s) to be prepared” in the SN change required message.
      2) In Step 413, MN 402 transmits a SN addition request message (e.g., SN ADDITION REQUEST Xn message) to a new SN associated with a candidate PSCell of UE 401, e.g., SN 404. In an embodiment, the SN addition request message includes the indicator or the IE which implies an initiation or a start of the CPC procedure.
      3) In Step 414, SN 404 transmits a SN addition request acknowledge message (e.g., SN ADDITION REQUEST ACKNOWLEDGE Xn message), which includes configuration(s) of candidate PSCell(s), to MN 302.
      4) In Step 415, MN 402 transmits a SN change confirm message (e.g., SN CHANGE CONFIRM Xn message) to SN 403.
   b) For a SN initiated intra SN CPC procedure, only Step 412 is performed. In Step 412, SN 403 transmits a modification required message (e.g., SN MODIFICATION REQUIRED Xn message) to MN 402. SN 403 adds “an indicator or IE which implies an initiation or a start of the CPC procedure” together with “SN RRC configuration(s) to be sent to UE 401” in the modification required message.
(3) Step 416: MN 402 transmits an RRC reconfiguration message, which includes the configuration(s) of candidate PSCell(s), to UE 401.
(4) Step 417: UE 401 transmits an RRC reconfiguration complete message to MN 402.

FIG. 5 illustrates a flow chart of an exemplary procedure of wireless communications in accordance with some embodiments of the present application. The exemplary procedure 500 refers to a successful PSCell change during a CPC procedure between a MN and a SN. In embodiments of FIG. 5, a new indicator or IE is used to indicate a successful PSCell change during a CPC procedure between a MN and a SN.

In legacy CPAC procedure, a UE may generate and send a SN RRC Reconfiguration Complete Uu message to a MN after the switch to a new PSCell is triggered. In the embodiments of FIG. 5, upon the switch to another PSCell when a CPC procedure is triggered, a UE informs the network about it. Triggering the CPC procedure means that the PSCell fulfils the execution condition and the UE starts a random access (RA) to the PSCell.

Referring to FIG. 5, UE 501, MN 502 and SN 503 may function as UE 101, MN 102, and SN 103 as shown in FIG. 1, respectively. SN 504 may be another SN not shown in FIG. 1. In particular, following steps are performed in the exemplary procedure 500.
(1) Step 511: UE 501, MN 502 and SN 503 perform a SN addition procedure, and UE 501 is connected to MN 502 and SN 503.
(2) Step 512: a CPC procedure is configured to UE 501, MN 502, SN 503, and SN 504.
(3) Step 513: UE 501 selects a PSCell, e.g., which is managed by SN 504.
(4) Step 514: UE 501 performs a RA to the selected PSCell managed by SN 504.
   a) In some embodiments of FIG. 5, every time UE 501 switches to a particular PSCell during a CPC procedure, UE 501 generates and transmits a reconfiguration complete message (e.g., a SN RRC Reconfiguration Complete message) encapsulated in an MN RRC message conveying the same RRC transaction identifier corresponding to configuration(s) related to the particular PSCell (e.g., the selected PSCell managed by SN 504). MN 502 will forward the reconfiguration complete message to the relevant SN conveyed in an Xn message (e.g., an RRC Transfer Xn message).
      1) From UE 501's point of view, for a CPC related RRC reconfiguration procedure, UE 501 will send multiple reconfiguration complete messages (including the same RRC-TransactionIdentifier) (e.g., RRC Reconfiguration Complete messages) for the same CPC related RRC reconfiguration procedure. UE 501 will not terminate the related RRC reconfiguration procedure upon sending a reconfiguration complete message.
      2) From the relevant SN's point of view (e.g., SN 504), for a CPC related RRC reconfiguration procedure, the relevant SN will receive multiple reconfiguration complete messages (including the same RRC-TransactionIdentifier) (e.g., RRC Reconfiguration Complete messages) for the same CPC related RRC reconfiguration procedure. The relevant SN will not terminate the related RRC reconfiguration procedure upon receiving a reconfiguration complete message.
   b) In some other embodiments of FIG. 5, when UE 501 receives RRC configuration(s) related to the CPC procedure, UE 501 generates and transmits one or more reconfiguration complete messages (e.g., SN RRC Reconfiguration Complete messages) for all related SN(s) encapsulated in an MN RRC message. MN 502 will forward the one or more reconfiguration complete messages to all relevant SN(s) conveyed in the Xn message (e.g., the RRC Transfer Xn message).
      1) In an embodiment, upon the switch to another PSCell is triggered, UE 501 does not send any further RRC message to indicate the triggered PSCell switch. The PSCell that receives the random access request message from UE 501 will understand that UE 501 attempts to switch to the PSCell.
(5) After Step 514, there may be following two options according to different embodiments, i.e., Option 1 and Option 2.
   a) Option 1: When the random access to the new PSCell is successful, the associated SN (e.g., SN 504) will inform MN 502 about the executed PSCell switch using a new defined Xn/X2 message or adding a new indicator or IE in existing Xn/X2 message including information about the new PSCell, e.g., PSCell ID. It can be either a class 1 (requires response from the peer node) or class 2 (does not require response from the peer node) Xn/X2 messaging procedure. For example:
      1) In a class 2 Xn/X2 messaging procedure, Step 515a is performed, in which SN 504 transmits an indicator or IE which implies a successful PSCell change during the CPC procedure to MN 502.
      2) In a class 1 Xn/X2 messaging procedure, besides Step 515a, Step 515b is further performed in which MN 502 transmits a response to SN 504.
   b) Option 2: When the random access to the new PSCell is successful, UE 501 will generate and send an RRC message (not RRC Reconfiguration Complete message) to MN 502 which conveys information about the new PSCell (e.g., PSCell ID) that UE 501 is going to switch to. In Step 515c, UE 501 transmits an RRC message (not RRC Reconfiguration Complete message) including an indicator or an IE which implies a successful PSCell change during the CPC procedure together with the information about the new PSCell (e.g., PSCell ID) to MN 502.
(6) After MN 502 is aware of the triggered or successfully executed PSCell switch and the information of the new PSCell (e.g., according to the embodiments in Step 514), MN 502 informs at least the SN related to the old PSCell (e.g., SN 503) about the trigger or successful execution of the PSCell switch, using a new defined Xn/X2 message or a new indicator or a new IE in existing Xn/X2 message conveying information about the new PSCell. It can be either a class 1 (requires response from the peer node) or class 2 (does not require response from the peer node) Xn/X2 messaging procedure.
   a) In a class 2 Xn/X2 messaging procedure, Step 516a is performed, in which MN 502 transmits the indicator or the IE which implies a successful PSCell change during the CPC procedure to SN 503.
   b) In a class 1 Xn/X2 messaging procedure, besides Step 516a, Step 516b is further performed in which SN 503 transmits a response to MN 502.

FIGS. 6-8 illustrate flowcharts of exemplary procedures of wireless communications in accordance with some embodiments of the present application. The exemplary procedures 600, 700, and 800 refer to a stop, a suspending, or a resumption of a CPC procedure between a MN and a SN. In embodiments of FIGS. 6-8, a new indicator or IE is used to indicate a stop, a suspending, or a resumption of a CPC procedure between a MN and a SN.

In particular, in some embodiments of the present application, a MN may trigger to stop a CPC procedure using a new defined Xn/X2 message or a new indicator or a new IE in existing Xn/X2 message. In an embodiment, a MN sends a new defined Xn/X2 message or adding a new indicator or a new IE in existing Xn/X2 message to the associated SN, to stop the CPC procedure in that SN. A specific embodiment is shown in FIG. 6.

Referring to FIG. 6, UE 601, MN 602 and SN 603 may function as UE 101, MN 102, and SN 103 as shown in FIG. 1, respectively. SN 604 may be another SN not shown in FIG. 1. In particular, the exemplary procedure 600 refers to a MN triggered stop of a CPC procedure, and following steps are performed.
(1) Step 611: UE 601, MN 602 and SN 603 perform a SN addition procedure, and UE 601 is connected to MN 602 and SN 603.
(2) Step 612: a CPC procedure is configured to UE 601, MN 602, SN 603, and SN 604. UE 601 is connected to a PSCell managed by SN 604. That is, SN 604 is a SN associated with the serving PSCell of UE 601, i.e., a current serving SN.
(3) After Step 612, there may be following different embodiments in different cases.
   a) Embodiment 1: If MN 602 wants to stop the CPC procedure, MN 602 may release one or more configurations of all PSCells related to the CPC procedure, so that UE 601 will only connect to MN 602. For example, MN 602 will generate a release request message (e.g., SN RELEASE REQUEST Xn message) and sends to all SNs, e.g., to SN 604 in Step 613 and/or to SN 603 in Step 615.
      1) The sequences of Steps 613 and 615 may be varied in different scenarios. That is, Step 613 may be performed before or after Step 615. Or, Steps 613 and 615 may be performed at the same time.
      2) Upon receiving the release request message, SN 603 and SN 604 will release all configuration(s) related to candidate PSCells. Then, SN 603 may transmit a release request response message (e.g., SN RELEASE REQUEST RESPONSE Xn message) in Step 616, and SN 604 may transmit a release request response message (e.g., SN RELEASE REQUEST RESPONSE Xn message) in Step 613A (for example) or other step not shown in FIG. 6. The sequences of Steps 616 and 613A may be varied in different scenarios.
   b) Embodiment 2: If MN 602 is aware of to which PSCell UE 601 is connected to at this moment, in case that MN 602 wants to stop the CPC procedure, MN 602 may let UE 601 keep a connection to the current serving PSCell which is managed by SN 604, but stopping the CPC procedure. There may be following steps.
      1) In Step 613, MN 602 transmits a new indicator or a new IE for indicating a stop of the CPC procedure to SN 604 which is associated with the current serving PSCell of UE 601. There may be following different embodiments.
         In a class 2 Xn/X2 messaging procedure, Step 613 is performed, in which MN 602 transmits a new defined Xn/X2 message including a new indicator or a new IE for indicating a stop of the CPC procedure to SN 604 which is associated with the current serving PSCell of UE 601.
         In a class 1 Xn/X2 messaging procedure, Step 613 is performed, in which MN 602 transmits a new defined Xn/X2 message or a modification request message (e.g., SN MODIFICATION REQUEST message), which includes a new indicator or a new IE for indicating a stop of the CPC procedure, to SN 604 which is associated with the current serving PSCell of UE 601. Besides Step 613, Step 613A is also performed in which SN 604 may transmit a response (e.g., SN MODIFICATION REQUEST ACKNOWLEDGE Xn message) to MN 602.
      2) Upon receiving the indicator of stopping the CPC procedure, SN 604 will release the configuration related to candidate PSCells except the current serving PSCell of UE 601. SN 604 also generate a SN RRC message and send to UE 601 in Step 614, so that UE 601 will also release the configuration related to candidate PSCell(s) except the current serving PSCell.
         The sequences of Steps 613A and 614 may be varied in different scenarios. That is, Step 613A may be performed before or after Step 614. Or, Steps 613A and 614 may be performed at the same time.
      3) In a case that there are multiple SNs involved in the CPC procedure, MN 602 will generate a release request message (e.g., SN RELEASE REQUEST Xn message) and sends to all other SN(s) (e.g., SN 603) associated with the CPC procedure but UE 601 is not connected to at the moment. For example:
         In Step 615, MN 602 transmits a release request (e.g., SN RELEASE REQUEST Xn message) to SN 603.
         In Step 616, after releasing all configuration(s) related to the candidate PSCells, SN 603 transmits a release request response message (e.g., SN RELEASE REQUEST RESPONSE Xn message) to MN 602.

In some further embodiments of the present application, a SN may trigger to stop a CPC procedure using a new defined Xn/X2 message or a new indicator or a new IE in existing Xn/X2 message. In an embodiment, either the source SN (which initiates the CPC procedure, i.e., when a UE receives configuration(s) of the CPC procedure) of the UE or the SN associated with the current serving PSCell of the UE can trigger a stop of the CPC procedure by sending to a MN via a new defined Xn/X2 message or by adding a new indicator or a new IE in existing Xn/X2 message. In an example, a source SN may send a new defined Xn/X2 message or send a SN CHANGE REQUIRED message with a new indicator or IE to a MN, to trigger a stop of a CPC procedure. In another example, the source SN may send a SN RELEASE REQUIRED message to the MN, if the UE is connected to a PSCell under another SN at that moment, which implicitly means the stop of CPC procedure. These two examples can be either a class 1 (requires response from the peer node) or class 2 (does not require response from the peer node) Xn/X2 messaging procedure. A specific embodiment is shown in FIG. 7.

Referring to FIG. 7, UE 701, MN 702 and SN 703 may function as UE 101, MN 102, and SN 103 as shown in FIG. 1, respectively. SN 704 may be another SN not shown in FIG. 1. A specific embodiment of the exemplary procedure 700 (named as Embodiment A for simplicity) refers to a current serving SN triggered stop of a CPC procedure. In Embodiment A, Steps 711-715 are performed, and Step 713A is optional.
(1) Step 711: UE 701, MN 702 and SN 703 perform a SN addition procedure, and UE 701 is connected to MN 702 and SN 703.
(2) Step 712: a CPC procedure is configured to UE 701, MN 702, SN 703, and SN 704. UE 701 is connected to a PSCell managed by SN 704. That is, SN 704 is a SN associated with the serving PSCell of UE 701, i.e., a current serving SN.
(3) After Step 712, there may be following different embodiments.
   a) In a class 2 Xn/X2 messaging procedure, Step 713 is performed, in which SN 704 transmits a new defined Xn/X2 message, which includes a new indicator or a new IE for indicating a stop of the CPC procedure, to MN 702.
   b) In a class 1 Xn/X2 messaging procedure, Step 713 is performed, in which SN 704 transmits a new defined Xn/X2 message or a change required message (e.g., SN CHANGE REQUIRED message) or a modification required message (e.g., SN MODIFICATION REQUIRED message), which includes a new indicator or a new IE for indicating a stop of the CPC procedure, to MN 702. Besides Step 713, Step 713A is further performed in which MN 702 transmits a response (e.g., SN CHANGE CONFIRM message or SN MODIFICATION CONFIRM message) to SN 704.
(4) Step 714: MN 702 transmits a release request message (e.g., SN RELEASE REQUEST message) to SN 703. UE 701 is not connected to a PSCell under SN 703 at that moment.
(5) Step 715: after releasing all configuration(s) related to the candidate PSCells, SN 703 transmits a release request response message (e.g., SN RELEASE REQUEST RESPONSE message) to MN 702.

In some other embodiments of the present application, after configuration(s) related to a CPC procedure has been configured to a UE and the CPC procedure has started, a MN or a SN may suspend and later resume the CPC procedure. Specific embodiments are shown in FIGS. 7 and 8.

In some embodiments, a suspending or a resumption of a CPC procedure is triggered by either a source SN (i.e., the connected SN when a UE receives the CPC configuration) or the current serving SN of the UE. In a SN triggered suspending or resumption of a CPC procedure, the SN will firstly send an Xn/X2 message including a new indicator for indicating the suspending or resumption of the CPC procedure. The Xn/X2 message could be either a class 1 (requires response from the peer node) or class 2 (does not require response from the peer node) Xn/X2 messaging procedure. The class 1 message could be a SN Modification Required Xn message. A MN will then inform other relevant SNs about the suspending or resumption of the CPC procedure. A specific embodiment is shown in FIG. 7.

A specific embodiment of the exemplary procedure 700 refers to “a current serving SN triggered suspending of a CPC procedure” or “a current serving SN triggered resumption of a CPC procedure” (named as Embodiment B for simplicity). In Embodiment B, Steps 711-714 are performed, with Step 713A is optional.
(1) Step 711: UE 701, MN 702 and SN 703 perform a SN addition procedure, and UE 701 is connected to MN 702 and SN 703.
(2) Step 712: a CPC procedure is configured to UE 701, MN 702, SN 703, and SN 704. UE 701 is connected to a PSCell managed by SN 704. That is, SN 704 is a SN associated with the serving PSCell of UE 701, i.e., a current serving SN.
(3) After Step 712, there may be following different embodiments.
   a) In a class 2 Xn/X2 messaging procedure, Step 713 is performed, in which SN 704 transmits a new defined Xn/X2 message, which includes a new indicator or a new IE for indicating a suspending or a resumption of the CPC procedure, to MN 702.
   b) In a class 1 Xn/X2 messaging procedure, Step 713 is performed, in which SN 704 transmits a new defined Xn/X2 message or a change required message (e.g., SN CHANGE REQUIRED message) or a modification required message (e.g., SN MODIFICATION REQUIRED message), which includes a new indicator or a new IE for indicating a suspending or a resumption of the CPC procedure, to MN 702. Besides Step 713, Step 713A is further performed in which MN 702 transmits a response (e.g., SN CHANGE CONFIRM message or SN MODIFICATION CONFIRM message) to SN 704.
(4) Step 714: MN 702 transmits a message, which includes the new indicator or the new IE for indicating the suspending or the resumption of the CPC procedure to SN 703. UE 701 is not connected to a PSCell under SN 703 at that moment.

In some other embodiments, a suspending or a resumption of a CPC procedure is triggered by a MN. The MN will send an Xn/X2 message including a new indicator or a new IE for indicating a suspending or a resumption of the CPC procedure to all SNs associated with the CPC procedure. The Xn/X2 message could be either a class 1 (requires response from the peer node) or class 2 (does not require response from the peer node) Xn/X2 messaging procedure. The class 1 message could be the SN Modification Request Xn message. A specific embodiment is shown in FIG. 8.

Referring to FIG. 8, UE 801, MN 802 and SN 803 may function as UE 101, MN 102, and SN 103 as shown in FIG. 1, respectively. SN 804 may be another SN not shown in FIG. 1. In particular, the exemplary procedure 800 refers to “a MN triggered suspending of a CPC procedure” or a “MN triggered resumption of a CPC procedure”, and following steps are performed.
(1) Step 811: UE 801, MN 802 and SN 803 perform a SN addition procedure, and UE 801 is connected to MN 802 and SN 803.
(2) Step 812: a CPC procedure is configured to UE 801, MN 802, SN 803, and SN 804. UE 801 is connected to a PSCell managed by SN 804. That is, SN 804 is a SN associated with the serving PSCell of UE 801, i.e., a current serving SN.
(3) After Step 812, there may be following different embodiments.
   a) In a class 2 Xn/X2 messaging procedure, Steps 813 and 814 are performed, in which MN 802 transmits a new defined Xn/X2 message, which includes a new indicator or a new IE for indicating a suspending or a resumption of the CPC procedure, to SN 803 and SN 804, respectively.
      1) The sequences of Steps 813 and 814 may be varied in different scenarios. That is, Step 813 may be performed before or after Step 814. Or, Steps 813 and 814 may be performed at the same time.
   b) In a class 1 Xn/X2 messaging procedure, Steps 813, 813A, 814, and 814A are performed. In Steps 813 and 814, MN 802 transmits a new defined Xn/X2 message or a modification request message (e.g., SN MODIFICATION REQUEST Xn message), which includes a new indicator or a new IE for indicating a suspending or a resumption of the CPC procedure, to SN 803 and SN 804, respectively. In Step 813A, SN 804 transmits a response to MN 802. In Step 814A, SN 803 transmits a response (e.g., SN MODIFICATION CONFIRM message) to MN 802.

Details described in all other embodiments of the present application are applicable for the embodiments shown in any of FIGS. 3-8. It should be appreciated by persons skilled in the art that the sequence of the operations in any of exemplary procedures 300-800 in FIGS. 3-8 may be changed and some of the operations in any of exemplary procedures 300-800 in FIGS. 3-8 may be eliminated or modified, without departing from the spirit and scope of the disclosure.

For instance, any of exemplary procedures 300-800 in FIGS. 3-8 may also be applicable for an eCPC procedure or a CCPC procedure. In some embodiments, the exemplary procedures 300 and 400 may be applicable for an initiation or a start of an eCPC or CCPC procedure between a MN and a SN. In some embodiments, the exemplary procedure 500 may be applicable for a successful PSCell change during an eCPC or CCPC procedure between a MN and a SN. In some embodiments, the exemplary procedures 600, 700, and 800 may be applicable for a stop, a suspending, or a resumption of an eCPC or CCPC procedure between a MN and a SN.

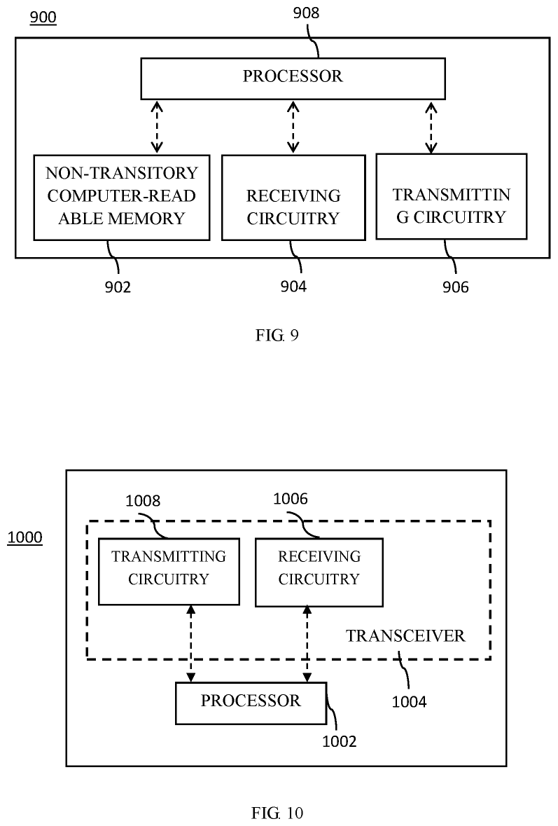

Some embodiments of the present application also provide a wireless communication apparatus for a CPC procedure. For example, FIG. 9 illustrates an exemplary block diagram of an apparatus 900 for a CPC procedure in accordance with some embodiments of the present application.

As shown in FIG. 9, the apparatus 900 may include at least one non-transitory computer-readable medium 902, at least one receiving circuitry 804, at least one transmitting circuitry 906, and at least one processor 908 coupled to the non-transitory computer-readable medium 902, the receiving circuitry 804 and the transmitting circuitry 906. The at least one processor 908 may be a CPU, a DSP, a microprocessor etc. The apparatus 900 may be a network node (e.g., a MN or a SN) configured to perform a method illustrated in the above or the like.

Although in this figure, elements such as the at least one processor 808, receiving circuitry 904, and transmitting circuitry 906 are described in the singular, the plural is contemplated unless a limitation to the singular is explicitly stated. In some embodiments of the present application, the receiving circuitry 904 and the transmitting circuitry 906 can be combined into a single device, such as a transceiver. In certain embodiments of the present application, the apparatus 900 may further include an input device, a memory, and/or other components.

In some embodiments of the present application, the non-transitory computer-readable medium 902 may have stored thereon computer-executable instructions to cause a processor to implement the methods with respect to a network node (e.g., a MN or a SN) as described or illustrated above. For example, the computer-executable instructions, when executed, cause the processor 808 interacting with receiving circuitry 904 and transmitting circuitry 906, so as to perform the steps with respect to a network node (e.g., a MN or a SN) as described or illustrated above.

FIG. 10 illustrates a further exemplary block diagram of an apparatus 1000 for a CPC procedure in accordance with some embodiments of the present application. Referring to FIG. 10, the apparatus 1000, for example a MN or a SN, may include at least one processor 1002 and at least one transceiver 1004 coupled to the at least one processor 1002. The transceiver 1004 may include at least one separate receiving circuitry 1006 and transmitting circuitry 1008, or at least one integrated receiving circuitry 1006 and transmitting circuitry 1008. The at least one processor 1002 may be a CPU, a DSP, a microprocessor etc.

According to some other embodiments of the present application, when the apparatus 1000 is a MN, the processor 1002 may be configured: to determine whether an operating status of a CPC procedure of a UE will change; and in response to determining that the operating status of the CPC procedure will change, to transmit a message via the transceiver 1004 to a SN, wherein the message includes an indication for indicating a change of the operating status of the CPC procedure.

According to some embodiments of the present application, when the apparatus 1000 is a SN, the processor 1002 is configured to communicate a message via the transceiver 1004 with a MN, wherein the message includes an indication for indicating a change of an operating status of a CPC procedure of a UE.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A master node (MN), comprising:
at least one memory; and
at least one processor coupled with the at least one memory and configured to cause the MN to:
determine whether an operating status of a conditional primary secondary cell group cell (PSCell) change (CPC) procedure of a user equipment (UE) will change; and
in response to determining that the operating status of the CPC procedure will change, transmit a first message to a first secondary node (SN), wherein the first message includes a first indication for indicating a change of the operating status of the CPC procedure.

2. The MN of claim 1, wherein a configuration related to the CPC procedure is not released by the UE upon the UE switching to a PSCell during the CPC procedure.

3. The MN of claim 1, wherein the change of the operating status of the CPC procedure includes at least one of:
an initiation of the CPC procedure;
a start of the CPC procedure;
a stop of the CPC procedure;
a suspending of the CPC procedure;
a resumption of the CPC procedure; or
a successful PSCell change during the CPC procedure.

4. The MN of claim 1, wherein the UE is connected to the first SN when receiving a configuration related to the CPC procedure, and wherein the at least one processor is configured to cause the MN to transmit a second message including the first indication to a second SN associated with a candidate PSCell of the UE.

5. The MN of claim 1, wherein the first SN is associated with a candidate PSCell of the UE during the CPC procedure, wherein the at least one processor is configured to cause the MN to receive a third message including the first indication from a SN to which the UE is connected when receiving a configuration related to the CPC procedure.

6. The MN of claim 1, wherein the at least one processor is configured to cause the MN to receive a first reconfiguration complete message associated with the CPC procedure from the UE.

7. The MN of claim 6, wherein the at least one processor is configured to cause the MN to receive a second reconfiguration complete message associated with the CPC procedure from the UE.

8. The MN of claim 7, wherein the first reconfiguration complete message and the second reconfiguration complete message are related to a same radio resource control (RRC) reconfiguration procedure identified by an RRC transaction identifier.

9. The MN of claim 1, wherein the first SN is associated with a target PSCell of the UE, and wherein the at least one processor is configured to cause the MN to receive a fifth message including the first indication from a sixth SN associated with a current serving PSCell of the UE or from a seventh SN to which the UE is connected when receiving a configuration related to the CPC procedure.

10. The MN of claim 9, wherein the change of the operating status of the CPC procedure includes at least one of:
a stop of the CPC procedure;
a suspending of the CPC procedure; or
a resumption of the CPC procedure.

11. The MN of claim 9, wherein, in response to the change of the operating status of the CPC procedure including a stop of the CPC procedure, the at least one processor is configured to cause the MN to:
release one or more configurations of all PSCells related to the CPC procedure; or
keep a connection between the UE and a current serving PSCell of the UE and to release one or more configurations of other PSCells related to the CPC procedure.

12. The MN of claim 11, wherein:
to release the one or more configurations of the all PSCells related to the CPC procedure, the at least one processor is configured to cause the MN to transmit a SN release request message to each SN within all SNs associated with the all PSCells; or
to release the one or more configurations of the other PSCells related to the CPC procedure, the at least one processor is configured to cause the MN to transmit the SN release request message to each SN within a set of SNs associated with the other PSCells.

13. The MN of claim 12, wherein to keep the connection between the UE and the current serving PSCell of the UE and to release the one or more configurations of the other PSCells related to the CPC procedure, the first message transmitted by the MN is a SN modification request message, and the SN is associated with the current serving PSCell of the UE.

14. A secondary node (SN), comprising:
at least one memory; and
at least one processor coupled with the at least one memory and configured to cause the SN to:
communicate a first message with a master node (MN), wherein the first message includes a first indication for indicating a change of an operating status of a conditional primary secondary cell group cell (PSCell) change (CPC) procedure of a user equipment (UE).

15. A method performed by a master node (MN), the method comprising:
determining whether an operating status of a conditional primary secondary cell group cell (PSCell) change (CPC) procedure of a user equipment (UE) will change; and
transmitting a first message to a secondary node (SN), wherein the first message includes a first indication for indicating a change of the operating status of the CPC procedure, in response to determining that the operating status of the CPC procedure will change.

16. The method of claim 15, wherein a configuration related to the CPC procedure is not released by the UE upon the UE switching to a PSCell during the CPC procedure.

17. The method of claim 15, wherein the change of the operating status of the CPC procedure includes at least one of:
an initiation of the CPC procedure;
a start of the CPC procedure;
a stop of the CPC procedure;
a suspending of the CPC procedure;
a resumption of the CPC procedure; or
a successful PSCell change during the CPC procedure.

18. The method of claim 15, wherein the UE is connected to the first SN when receiving a configuration related to the CPC procedure, and the method further comprises transmitting a second message including the first indication to a second SN associated with a candidate PSCell of the UE.

19. The method of claim 15, wherein the first SN is associated with a candidate PSCell of the UE during the CPC procedure, and the method further comprises receiving a third message including the first indication from a SN to which the UE is connected when receiving a configuration related to the CPC procedure.

20. A method performed by a secondary node (SN), the method comprising:
communicating a first message with a master node (MN), wherein the first message includes a first indication for indicating a change of an operating status of a conditional primary secondary cell group cell (PSCell) change (CPC) procedure of a user equipment (UE).
